(19) United States
(12) Patent Application Publication
(10) Pub. No.: US 2026/0355993 A1
(43) Pub. Date: Nov. 12, 2026

(54) RAZOR CARTRIDGE

(71) Applicant: DORCO CO., LTD., Seoul (KR)

(72) Inventors: Seung Mi SHIN, Seoul (KR); Nam Yoon KONG, Seoul (KR)

(21) Appl. No.: 19/667,301

(22) Filed: May 4, 2026

(30) Foreign Application Priority Data
May 7, 2025 (KR) 10-2025-0059207
Apr. 8, 2026 (KR) 10-2026-0063597

(51) Int. Cl. B26B 21/44; B26B 21/22

(52) U.S. Cl. CPC B26B 21/443; B26B 21/225

(57) ABSTRACT

A razor cartridge may include at least one razor blade having a cutting edge formed at an end thereof to face forward, and a frame configured to longitudinally receive the at least one razor blade such that at least a portion of the cutting edge is exposed upward. The razor cartridge may also include a rear support portion extending rearward from the frame, and a rear lubricating member supported by the rear support portion. The rear support portion may include a rear connection portion connected to the frame along a longitudinal direction, a rear edge portion extending in an arc shape from both sides of the rear connection portion, and a plurality of rear ribs connecting the rear connection portion and the rear edge portion. The plurality of rear ribs may be formed to extend at angles not parallel to a shaving direction.

### CROSS REFERENCE TO RELATED APPLICATION

Priority to Korean patent application number 10-2025-0059207 filed on May 7, 2025, and Korean patent application number 10-2026-0063597 filed on Apr. 8, 2026, the entire disclosure of which is incorporated by reference herein, is claimed.

### BACKGROUND

### Technical Field

The present disclosure relates to a razor cartridge, and more particularly, to a razor cartridge including a lubricating member provided at a front and/or a rear of a razor blade.

### Description of Related Technology

A razor cartridge has a structure including a razor blade, and is provided in various forms depending on its intended use and target users. In particular, in the case of a body razor or a razor for women, cartridges having a soap or a lubricating strip provided at a front and a rear of the razor blade are widely used in order to alleviate skin irritation and improve a smooth feeling during shaving. Such a structure reduces friction between the skin and the razor blade during shaving, and enables relatively smooth shaving even without using a separate shaving aid, thereby being highly preferred by female users.

### SUMMARY

One aspect is a razor cartridge capable of more effectively preventing separation of a lubricating member provided at a front and/or a rear of a razor blade.

The aspects of the present disclosure are not limited to those described herein, and other aspects not described herein will be clearly understood by those skilled in the art from the following description.

Another aspect is a razor cartridge that includes a razor blade having a cutting edge formed at an end thereof to face forward, a frame configured to longitudinally receive at least one razor blade such that at least a portion of the cutting edge is exposed upward, a rear support portion extending rearward from the frame, and a rear lubricating member supported by the rear support portion, wherein the rear support portion includes a rear connection portion connected to the frame along a longitudinal direction, a rear edge portion extending in an arc shape from both sides of the rear connection portion, and a plurality of rear ribs connecting the rear connection portion and the rear edge portion, and the plurality of rear ribs are formed to extend at an angle not parallel to a shaving direction.

Another aspect is a razor cartridge that includes a razor blade having a cutting edge formed at an end thereof to face forward, a frame configured to longitudinally receive at least one razor blade such that at least a portion of the cutting edge is exposed upward, a rear support portion extending rearward from the frame and having a plurality of triangular through-holes formed therein, and a rear lubricating member supported by the rear support portion.

Other specific features of the present disclosure are included in the detailed description and the drawings.

According to embodiments of the present disclosure, at least the following effect is achieved.

Separation of a lubricating member provided at a front and/or a rear of the razor blade is prevented.

The effects according to the present disclosure are not limited to those described above, and various other effects are included in the present specification.

### BRIEF DESCRIPTION OF THE DRAWINGS

FIG. 1 is a perspective view illustrating a top surface of a razor cartridge according to an embodiment of the present disclosure.

FIG. 2 is a perspective view illustrating a bottom surface of the razor cartridge according to the embodiment of the present disclosure.

FIG. 3 is a side view of the razor cartridge according to the embodiment of the present disclosure.

FIG. 4 is an exploded perspective view of the razor cartridge according to the embodiment of the present disclosure.

FIG. 5 is a bottom view illustrating a rear support portion.

FIG. 6 is a plan view illustrating a front support portion.

FIG. 7 is a side view of the razor cartridge in which a front lubricating member and a rear lubricating member are removed.

### DETAILED DESCRIPTION

In razor cartridges for women, due to repeated friction during use or dissolution caused by water, the soap provided at the front or the rear of the razor blade is often separated from the cartridge, or a portion of the soap is detached, or at least a portion of the soap is displaced from its original position.

Such separation or detachment of the soap may cause cuts during shaving and reduces user satisfaction with respect to durability of the product. In addition, when the soap is separated at an early stage, it becomes difficult to normally use the razor cartridge, which may lead to problems such as a shortened product lifespan and increased replacement cost.

The advantages and features of the present disclosure, and methods for achieving the same, will become apparent with reference to embodiments described in detail below in conjunction with the accompanying drawings. However, the present disclosure is not limited to the embodiments disclosed herein and may be implemented in various different forms. These embodiments are provided only to make the disclosure of the present disclosure complete and to fully inform those skilled in the art of the scope of the invention, and the present disclosure is defined only by the scope of the claims.

In addition, the embodiments described in the present specification will be explained with reference to cross-sectional views and/or schematic views, which are ideal illustrations of the present disclosure. Accordingly, the shapes of the illustrated figures may be modified due to manufacturing techniques and/or tolerances. Further, in the drawings of the present disclosure, respective components may be illustrated as being somewhat enlarged or reduced for convenience of description. Throughout the specification, like reference numerals refer to like elements.

Hereinafter, the present disclosure will be described with reference to drawings for explaining a razor cartridge according to an embodiment of the present disclosure.

In the following description with reference to the drawings, a longitudinal direction refers to a lengthwise direction of a razor cartridge 1. For example, the longitudinal direction may be parallel to an X-axis of the drawings. A transverse direction refers to a direction perpendicular to the longitudinal direction. For example, the transverse direction may be parallel to a Y-axis of the drawings. In addition, a front and a rear may be defined based on a shaving direction, wherein the front corresponds to a negative Y-axis direction and the rear corresponds to a positive Y-axis direction. Further, an upward direction and a downward direction may be defined based on a height direction of the razor cartridge 1, which is perpendicular to the longitudinal direction and the transverse direction, wherein the upward direction corresponds to a positive Z-axis direction and the downward direction corresponds to a negative Z-axis direction.

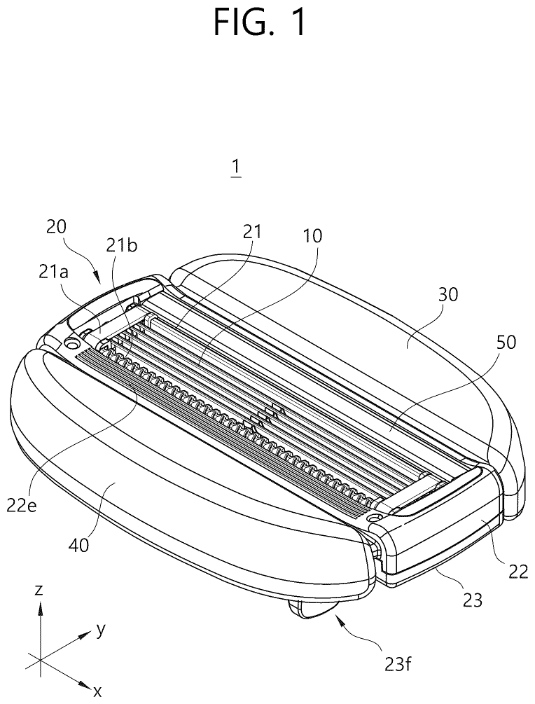

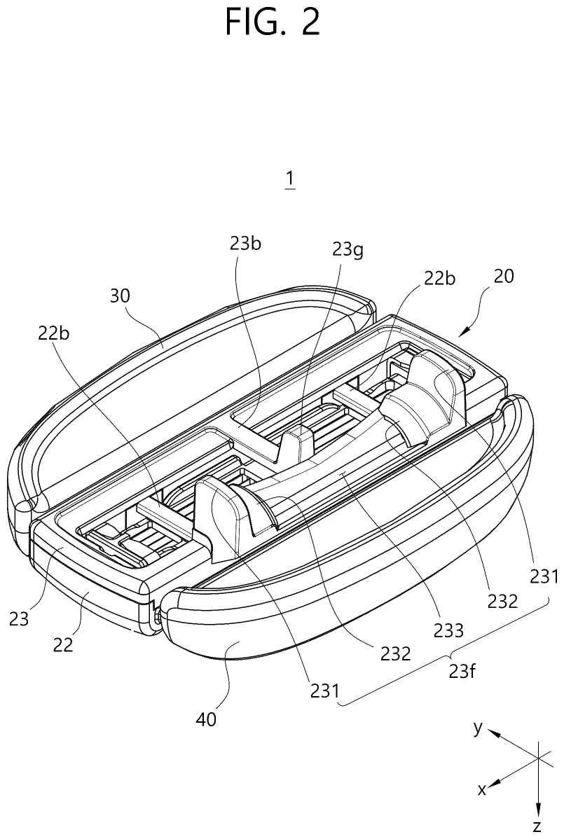

FIG. 1 is a perspective view illustrating a top surface of a razor cartridge according to an embodiment of the present disclosure, and FIG. 2 is a perspective view illustrating a bottom surface of the razor cartridge according to the embodiment of the present disclosure.

Referring to FIGS. 1 and 2, a razor cartridge 1 according to an embodiment of the present disclosure may include at least one razor blade 10, a frame 20, a rear lubricating member 30, and a front lubricating member 40.

The frame 20 longitudinally receives at least one razor blade 10. A plurality of razor blades 10 may be arranged in a row in the transverse direction within the frame 20. Although FIG. 1 and the like illustrate an example in which six razor blades 10 are received in the frame 20, the number of razor blades 10 may vary depending on embodiments.

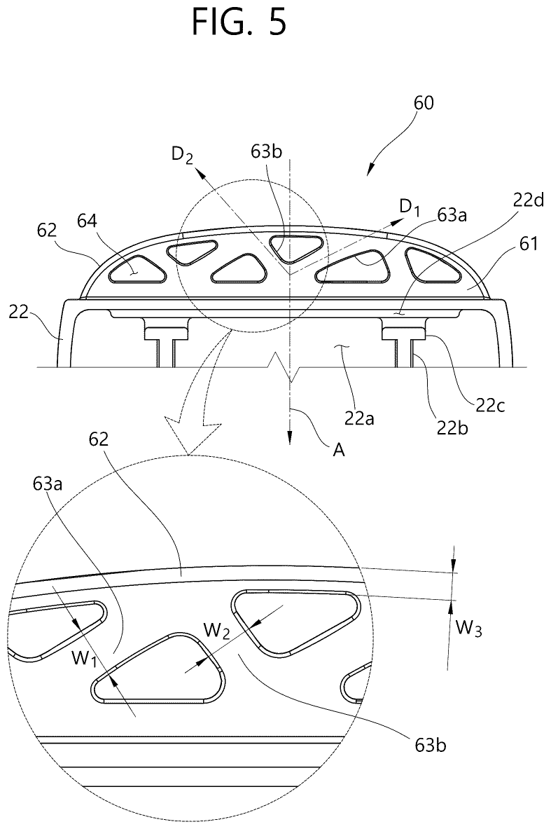

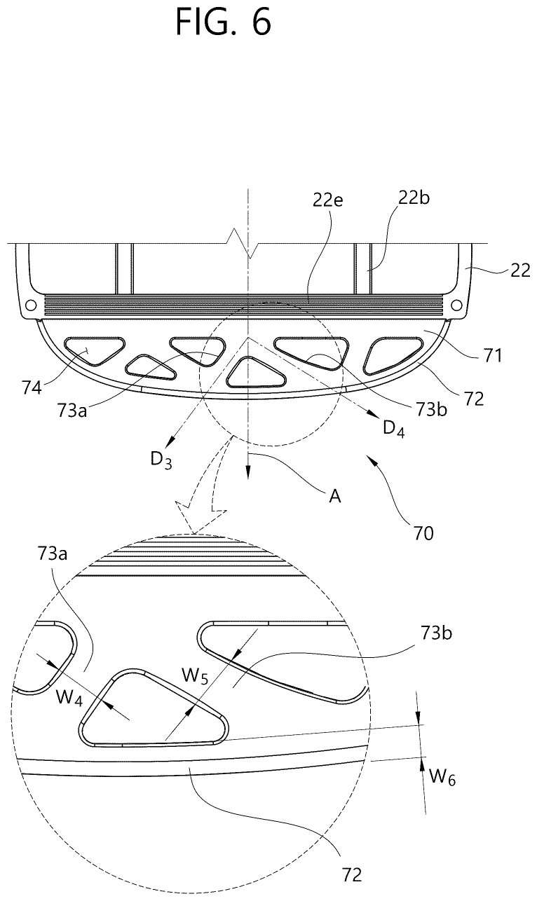

A cutting edge formed at an end of each razor blade 10 is exposed through a top surface of the frame 20, and may be formed to be inclined toward the front of the frame 20. The front of the frame 20 is a direction in which the razor cartridge 1 moves relative to a user's skin during a shaving process, and may be referred to as a shaving direction A (see FIGS. 5 and 6).

Both sides of the razor blade 10 may be supported by clips 21a. The clips 21a prevent the plurality of razor blades 10 from being separated from the frame 20. To this end, the clips 21a may be coupled to the frame 20 while surrounding both sides of the plurality of razor blades 10 along the transverse direction. The manner in which the clips 21a support the razor blades 10 may be variously modified. In addition, instead of the clips 21a, a separate configuration (for example, a separate cover member) for preventing the razor blades 10 from being separated from the frame 20 may be used.

On the top surface of the frame 20, a guard 21b, 22e positioned at the front of the razor blade 10 and a cap positioned at the rear of the razor blade 10 may be provided. The cap may include a lubricating band 50.

The guard 21b, 22e may include an elastic guard 22e and/or a comb 21b.

The comb 21b aligns hairs entering the razor blade 10. To this end, the comb 21b may be composed of a plurality of protrusions arranged along the longitudinal direction at fine intervals.

The elastic guard 22e comes into close contact with a user's skin during a shaving process and pulls the skin to improve a shaving effect by the razor blade 10. In order for the elastic guard 22e to more effectively pull the user's skin, a pattern formed as protrusions or recesses may be formed on a top surface of the elastic guard 22e, and the top surface of the elastic guard 22e may be formed of an elastic material such as rubber or silicone. According to an embodiment, the elastic guard 22e may be provided as a component separate from the frame 20.

The lubricating band 50 positioned at the rear of the razor blade 10 includes a lubricating material, and allows the lubricating material to be applied to a skin surface over which the razor blade 10 has passed during shaving. The lubricating material may include components for protecting the skin after shaving. The lubricating band 50 may be provided as a component separate from the frame 20, but according to an embodiment, the lubricating band 50 may be integrally formed with the frame 20.

Referring to FIG. 2, the frame 20 may include a cam 23g protruding downward from a bottom surface thereof. In a state in which the razor cartridge 1 is coupled to a razor handle (not shown), the cam 23g may contact a plunger (not shown) of the razor handle to be described later to define a pivoting motion of the razor cartridge 1.

The frame 20 may further include a cam support portion 23b on the bottom surface, and the cam 23g may be formed to protrude downward from the cam support portion 23b. According to an embodiment, the cam support portion 23b may be provided at a central portion of the bottom surface of the frame 20 to support a lower portion of the razor blade 10.

The frame 20 may include a cartridge connector 23f. The cartridge connector 23f is configured to be detachably coupled to a razor handle. The cartridge connector 23f may be provided on the bottom surface of the frame 20, and may be coupled to the frame 20 or integrally formed with the frame 20. The cartridge connector 23f may be fixed to the frame 20 or may be provided to be pivotable with respect to the blade frame 20.

In order for shaving debris (for example, shaving cream, cut hairs, etc.) to be effectively discharged together with washing water through spaces between the plurality of razor blades 10, the cartridge connector 23f may be formed at a position not overlapping with the razor blades 10 in the height direction. In this case, the cartridge connector 23f may be positioned below the elastic guard 22e.

The cartridge connector 23f may include a pair of guide posts 231, a pair of guide surfaces 232, and a connector receiving space 233.

The pair of guide posts 231 may be formed to protrude downward from the frame 20 while being spaced apart from each other in the longitudinal direction with the connector receiving space 233 interposed therebetween. The connector receiving space 233 defines a space into which a connector of a razor handle is inserted.

The pair of guide surfaces 232 extend from the pair of guide posts 231 toward a center of the frame 20. The pair of guide surfaces 232 may be formed to cover portions of both sides of the connector receiving space 233. That is, the connector receiving space 233 may extend up to an upper portion of the pair of guide surfaces 232.

The pair of guide surfaces 232 guide the connector of the razor handle to be easily inserted into the connector receiving space 233. To this end, each guide surface 232 may include an inclined surface forming a downward slope toward the connector receiving space 233.

In a state in which the razor cartridge 1 is coupled to the razor handle, the connector of the razor handle positioned in the connector receiving space 233 is prevented from being separated rearward by the pair of guide surfaces 232.

A pivot axis of the razor cartridge 1 with respect to the razor handle may pass through the connector receiving space 233. Accordingly, the pivot axis of the razor cartridge 1 may be parallel to the longitudinal direction.

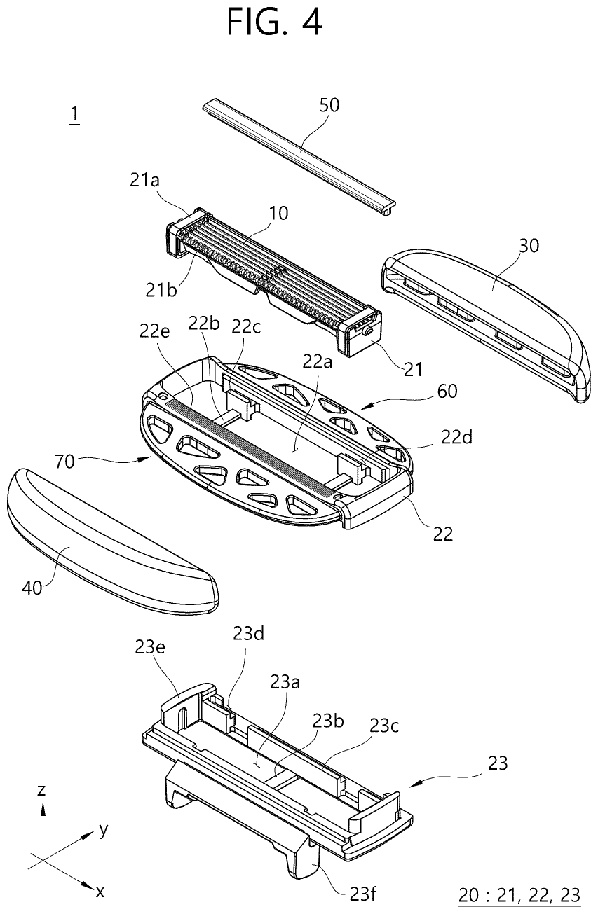

The rear lubricating member 30 may be provided at the rear of the razor blade 10 and the frame 20, and the front lubricating member 40 may be provided at the front of the razor blade 10 and the frame 20. A rear support portion 60 (see FIG. 4) supporting the rear lubricating member 30 and a front support portion 70 (see FIG. 4) supporting the front lubricating member 40 may be integrally formed with the frame 20, or may be separate members assembled to or attached to the frame 20.

The front lubricating member 40 and the rear lubricating member 30 may be in close contact with the skin during a shaving process to apply a shaving aid material to a skin surface on which shaving is performed. The front lubricating member 40 and the rear lubricating member 30 may include shaving aid materials such as a lubricating material, a skin soothing material, a skin moisturizing material, and a skin regenerating material.

The front lubricating member 40 and the rear lubricating member 30 may be formed such that a maximum length in the longitudinal direction is greater than a longitudinal length of the razor blade 10 exposed through the frame 20. Accordingly, the front lubricating member 40 and the rear lubricating member 30 may apply the shaving aid material to an entire skin surface on which shaving is performed.

In order for the razor cartridge 1 to smoothly move on the skin surface along the shaving direction A, the front lubricating member 40 may be formed such that a longitudinal length thereof increases toward the rear, and the rear lubricating member 30 may be formed such that a longitudinal length thereof decreases toward the rear.

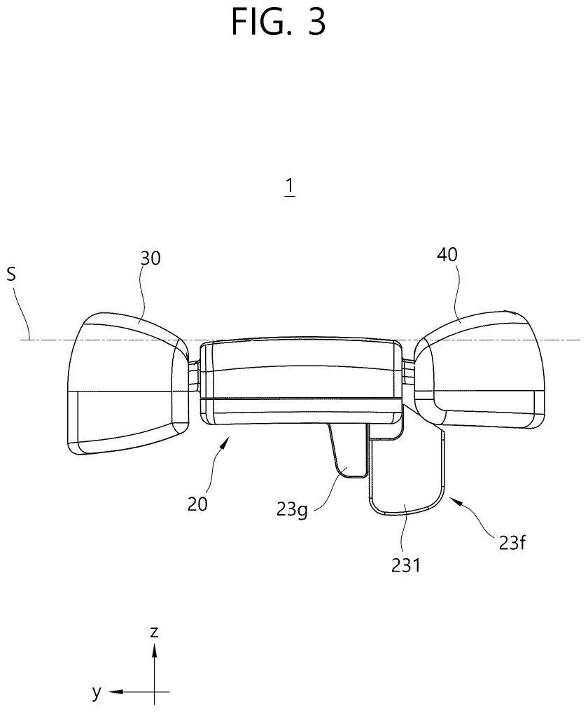

FIG. 3 is a side view of a razor cartridge according to an embodiment of the present disclosure.

The front lubricating member 40 and the rear lubricating member 30 may be formed such that upper ends thereof are positioned above a shaving plane S.

The shaving plane S is a plane on which a user's skin is assumed to be positioned during a shaving process or a plane on which actual shaving is performed. For example, the shaving plane S may be defined as a plane simultaneously contacting upper ends of the guard 21b, 22e and the cap. Alternatively, the shaving plane S may be defined as a plane simultaneously contacting a highest point of a component positioned between the front lubricating member 40 and the razor blade 10 and a highest point of a component positioned between the rear lubricating member 30 and the razor blade 10.

Since at least a portion of the upper ends or the highest points of the front lubricating member 40 and the rear lubricating member 30 are positioned above the shaving plane S, a close-contact state between the front lubricating member 40 and the rear lubricating member 30 and a skin surface, which actually forms a curved shape, may be smoothly maintained. Further, even when the front lubricating member 40 and the rear lubricating member 30 are worn to some extent, close contact with the skin surface may be maintained. When the front support portion 70 supporting the front lubricating member 40 includes a front connection portion 71 (see FIG. 6) elastically supported with respect to the frame 20, contact performance between the front lubricating member 40 and the skin surface may be further improved. In addition, when the rear support portion 60 supporting the rear lubricating member 30 includes a rear connection portion 61 (see FIG. 5) elastically supported with respect to the frame 20, contact performance between the rear lubricating member 30 and the skin surface may be further improved. In order to increase a contact area between the skin surface and each of the lubricating members 30 and 40, a top surface of the rear lubricating member 30 may be formed to have an upward slope toward the rear with respect to the shaving plane S, and a top surface of the front lubricating member 40 may be formed to have an upward slope toward the front with respect to the shaving plane S.

FIG. 4 is an exploded perspective view of a razor cartridge according to an embodiment of the present disclosure.

Referring to FIG. 4, the frame 20 may include a first frame 21 supporting a razor blade, a second frame 22 supporting the front lubricating member 40 and the rear lubricating member 30, and a third frame 23 in which the cartridge connector 23f is formed. The first frame 21 may be referred to as a blade frame, the second frame 22 may be referred to as a lubricating member frame, and the third frame 23 may be referred to as a connecting frame. However, according to embodiments, at least some of the first frame 21, the second frame 22, and the third frame 23 may be integrally formed. For example, the second frame 22 and the third frame 23 may be integrally formed. Hereinafter, for convenience of description, an example in which three frames 21, 22, and 23 are provided will be described.

The first frame 21 receives at least one razor blade 10. The clips 21a may surround both sides of the first frame 21 in the transverse direction to prevent the razor blade 10 from being separated from the first frame 21. The comb 21b may be formed at a front end of the first frame 21.

The second frame 22 forms a first receiving space 22a at a center thereof to receive the first frame 21, and is formed to surround at least a portion of the first receiving space 22a.

The second frame 22 may include at least one support bar 22b extending across a lower portion of the first receiving space 22a in the transverse direction. The support bar 22b may support a lower portion of the first frame 21 and/or a lower portion of the razor blade 10.

The second frame 22 may include a first band support end 22c supporting the lubricating band 50. The first band support end 22c may be provided to face a rear wall of the second frame 22 with a gap therebetween. The gap between the first band support end 22c and the rear wall of the second frame 22 may define a band receiving space 22d into which a portion of the lubricating band 50 is inserted. The first band support end 22c may be formed to extend upward from the support bar 22b.

The second frame 22 may include the elastic guard 22e. Referring to FIG. 4, the elastic guard 22e may be formed on a top surface of the second frame 22 positioned at a front of the first receiving space 22a. According to an embodiment, the elastic guard 22e may be manufactured separately from the second frame 22.

The second frame 22 may support the rear support portion 60 and the front support portion 70.

The rear support portion 60 may extend rearward from the second frame 22. The rear support portion 60 may be formed to extend rearward from a rear wall of the second frame 22, and may be provided to be elastically deformable with respect to the second frame 22. The rear support portion 60 supports the rear lubricating member 30. The rear lubricating member 30 may be formed to surround both an upper surface and a lower surface of the rear support portion 60.

The front support portion 70 may extend forward from the second frame 22. The front support portion 70 may be formed to extend forward from a front wall of the second frame 22, and may be provided to be elastically deformable with respect to the second frame 22. The front support portion 70 may be positioned in front of the elastic guard 22e. The front support portion 70 supports the front lubricating member 40. The front lubricating member 40 may be formed to surround both an upper surface and a lower surface of the front support portion 70.

Further description of the rear support portion 60 and the front support portion 70 will be provided below.

The third frame 23 forms a second receiving space 23a accommodating at least a portion of the first frame 21 and the second frame 22, and is formed to surround at least a portion of the second receiving space 23a.

The third frame 23 may include a cam support portion 23b extending across a lower portion of the second receiving space 23a in the transverse direction. The cam support portion 23b may support a lower portion of the first frame 21 and/or a lower portion of the razor blade 10.

The third frame 23 may include a second band support end 23c supporting the lubricating band 50. The second band support end 23c may be formed to be aligned with the first band support end 22c in the longitudinal direction. In a state in which the second frame 22 and the third frame 23 are coupled, the second band support end 23c faces the rear wall of the second frame 22 with a gap therebetween, and the gap between the second band support end 23c and the rear wall of the second frame 22 may define a band receiving space 23d into which a portion of the lubricating band 50 is inserted.

The third frame 23 may include side wall portions 23e formed at both sides of the second receiving space 23a in the longitudinal direction. The side wall portions 23e may be inserted between the first frame 21 and the second frame 22 to more firmly couple the first frame 21, the second frame 22, and the third frame 23.

The third frame 23 may include the above-described cartridge connector 23f, and the cartridge connector 23f may be formed to extend rearward from a front end on a bottom surface of the third frame 23.

FIG. 5 is a bottom view illustrating the rear support portion.

Referring to FIG. 5, the rear support portion 60 may include a rear connection portion 61, a rear edge portion 62, a plurality of rear ribs 63a, 63b, and a plurality of rear through-holes 64.

The rear connection portion 61 is connected to a rear end of the second frame 22 along the longitudinal direction. According to an embodiment, in order for the rear support portion 60 to be elastically supported with respect to the second frame 22, the rear connection portion 61 may be formed of an elastically deformable material. In this case, the rear lubricating member 30 may pivot with respect to the frame 20 according to curvature of the skin and elastically support the skin.

The rear edge portion 62 may be formed to extend in an arc shape from both sides of the rear connection portion 61. Although FIG. 5 illustrates an example in which the rear edge portion 62 forms a single arc, according to embodiments, the rear edge portion 62 may be formed to extend while forming a plurality of arcs. The plurality of arcs may include, for example, a form in which arcs convex outward are continuously arranged, or a form in which arcs convex outward and arcs convex inward are alternately arranged. According to embodiments, the rear edge portion 62 may extend in a shape other than an arc from both sides of the rear connection portion 61, and may be modified to have any outer contour within a range permitted by functional or structural constraints.

The plurality of rear ribs 63a, 63b may be formed to connect the rear connection portion 61 and the rear edge portion 62, which are spaced apart from each other. The plurality of rear ribs 63a, 63b may include at least one first rear rib 63a and at least one second rear rib 63b. The first rear rib 63a and the second rear rib 63b may be formed to extend at an angle that is not parallel to both the shaving direction A and the longitudinal direction perpendicular to the shaving direction A.

Referring to FIG. 5, an extension direction D1 of the first rear rib 63a may form an acute angle with respect to the transverse direction parallel to the shaving direction A on one side, and an extension direction D2 of the second rear rib 63b may form an acute angle with respect to the transverse direction parallel to the shaving direction A on the other side. That is, the first rear rib 63a and the second rear rib 63b are formed to extend at angles different from the shaving direction A and may extend in different directions from each other.

The first rear ribs 63a and the second rear ribs 63b may be alternately arranged along the longitudinal direction. Some of the first rear ribs 63a and some of the second rear ribs 63b may be configured such that the spacing therebetween decreases toward the rear connection portion 61 and increases toward the rear edge portion 62. Other ones of the first rear ribs 63a and the second rear ribs 63b may be configured such that the spacing therebetween increases toward the rear connection portion 61 and decreases toward the rear edge portion 62. In addition, one of the second rear ribs 63b may be configured such that, relative to a first rear rib 63a adjacent on one side, the spacing between the second rear rib 63b and the first rear rib 63a decreases toward the rear edge portion 62 and increases toward the rear connection portion 61, and, relative to another first rear rib 63a adjacent on the opposite side, the spacing between the second rear rib 63b and the first rear rib 63a increases toward the rear edge portion 62 and decreases toward the rear connection portion 61. Alternatively, one of the first rear ribs 63a may be configured such that, relative to a second rear rib 63b adjacent on one side, the spacing between the first rear rib 63a and the second rear rib 63b decreases toward the rear edge portion 62 and increases toward the rear connection portion 61, and, relative to another second rear rib 63b adjacent on the opposite side, the spacing between the first rear rib 63a and the second rear rib 63b increases toward the rear edge portion 62 and decreases toward the rear connection portion 61.

An angle between the rear connection portion 61 and the first rear rib 63a may be different from an angle between the rear connection portion 61 and the second rear rib 63b.

Angles between the rear connection portion 61 and at least some of the plurality of first rear ribs 63a may be different from each other. For example, the plurality of first rear ribs 63a may be arranged such that first rear ribs 63a located closer to one side in the longitudinal direction (the right side in FIG. 5) have smaller or larger angles with respect to the rear connection portion 61.

Angles between the rear connection portion 61 and at least some of the plurality of second rear ribs 63b may be different from each other. For example, the plurality of second rear ribs 63b may be arranged such that second rear ribs 63b located closer to one side in the longitudinal direction (the right side in FIG. 5) have larger or smaller angles with respect to the rear connection portion 61.

However, according to embodiments, the angle between the rear connection portion 61 and the first rear rib 63a and the angle between the rear connection portion 61 and the second rear rib 63b may be the same, the angles between the rear connection portion 61 and the plurality of first rear ribs 63a may be the same, and the angles between the rear connection portion 61 and the plurality of second rear ribs 63b may also be the same.

A main component of a force acting on the rear lubricating member 30 during shaving is parallel to the shaving direction A. However, in the razor cartridge 1 according to the present embodiment, since the first rear ribs 63a and the second rear ribs 63b are formed not to be parallel to the shaving direction A, the rear lubricating member 30 may be prevented from being separated from the rear support portion 60 by the force generated during shaving. Further, since the first rear ribs 63a and the second rear ribs 63b extend at different angles, and in particular, extend in opposite directions with respect to the shaving direction A, separation of the rear lubricating member 30 from the rear support portion 60 may be more effectively prevented. In addition, since extension directions of the plurality of first rear ribs 63a are different from each other and extension directions of the plurality of second rear ribs 63b are different from each other, separation of the rear lubricating member 30 from the rear support portion 60 may be more effectively prevented.

In order to provide firm support for the rear lubricating member 30 and to prevent separation thereof, widths W1 and W2 of the plurality of rear ribs 63a, 63b may be formed to be greater than a width W3 of the rear edge portion 62, and the rear edge portion 62 may be formed to be thicker in the height direction than the plurality of rear ribs 63a, 63b, and may be formed to have a step relative to the plurality of rear ribs 63a, 63b in an upward direction and/or a downward direction.

Referring to FIG. 5, the rear support portion 60 may include a plurality of rear through-holes 64.

The rear through-holes 64 may be formed to be surrounded by at least three of the rear connection portion 61, the rear edge portion 62, the first rear ribs 63a, and the second rear ribs 63b. The rear through-holes 64 may be formed in a substantially triangular shape, and may be referred to as triangular through-holes.

Some of the rear through-holes 64 may be defined such that the rear connection portion 61 forms a first side, the first rear rib 63a forms a second side, and the second rear rib 63b forms a third side. Some of the rear through-holes 64 may be defined such that the rear edge portion 62 forms a first side, the first rear rib 63a forms a second side, and the second rear rib 63b forms a third side. Some of the rear through-holes 64 may be defined such that the rear connection portion 61 forms a first side, the rear edge portion 62 forms a second side, and the first rear rib 63a or the second rear rib 63b forms a third side.

The plurality of rear through-holes 64 may have different shapes and/or sizes, and each of the rear through-holes 64 may be asymmetric on both sides with respect to the transverse direction. The plurality of rear through-holes 64 may be formed to be asymmetric as a whole with respect to a central axis parallel to the shaving direction A. This may result from, as described above, differences in extension angles between the first rear ribs 63a and the second rear ribs 63b, differences in extension angles among the plurality of first rear ribs 63a, differences in extension angles among the plurality of second rear ribs 63b, and/or an arc shape of the rear edge portion 62.

The rear through-holes 64 define spaces into which the rear lubricating member 30 is filled. Accordingly, a shape, size, and an area ratio of the rear through-holes 64 with respect to the rear support portion are major factors affecting prevention of separation of the rear lubricating member 30. The razor cartridge 1 according to the present embodiment includes a plurality of triangular rear through-holes 64 having different shapes and/or sizes, thereby sufficiently securing an area of the rear through-holes 64 and simultaneously supporting the rear lubricating member 30 from various angles, so that separation of the rear lubricating member 30 may be more effectively prevented.

By the above-described structure and the like, the rear support portion 60 may be formed to be asymmetric with respect to a transverse central axis. Such a configuration more effectively prevents separation of the rear lubricating member 30.

FIG. 6 is a plan view illustrating the front support portion.

Referring to FIG. 6, the front support portion 70 may include a front connection portion 71, a front edge portion 72, a plurality of front ribs 73a, 73b, and a plurality of front through-holes 74.

The front connection portion 71 is connected to a front end of the second frame 22 along the longitudinal direction. According to an embodiment, in order for the front support portion 70 to be elastically supported with respect to the second frame 22, the front connection portion 71 may be formed of an elastically deformable material. In this case, the front lubricating member 40 may pivot with respect to the frame 20 according to curvature of the skin and elastically support the skin.

The front edge portion 72 may be formed to extend in an arc shape from both sides of the front connection portion 71. Although FIG. 6 illustrates an example in which the front edge portion 72 forms a single arc, according to embodiments, the front edge portion 72 may be formed to extend while forming a plurality of arcs. The plurality of arcs may include, for example, a form in which arcs convex outward are continuously arranged, or a form in which arcs convex outward and arcs convex inward are alternately arranged. According to embodiments, the front edge portion 72 may extend in a shape other than an arc from both sides of the front connection portion 71, and may be modified to have any outer contour within a range permitted by functional or structural constraints.

The plurality of front ribs 73a, 73b may be formed to connect the front connection portion 71 and the front edge portion 72, which are spaced apart from each other. The plurality of front ribs 73a, 73b may include at least one first front rib 73a and at least one second front rib 73b. The first front rib 73a and the second front rib 73b may be formed to extend at an angle that is not parallel to both the shaving direction A and the longitudinal direction perpendicular to the shaving direction A.

Referring to FIG. 6, an extension direction D3 of the first front rib 73a may form an acute angle with respect to the transverse direction parallel to the shaving direction A on one side, and an extension direction D4 of the second front rib 73b may form an acute angle with respect to the transverse direction parallel to the shaving direction A on the other side. That is, the first front rib 73a and the second front rib 73b are formed to extend at angles different from the shaving direction A and may extend in different directions from each other.

The first front ribs 73a and the second front ribs 73b may be alternately arranged along the longitudinal direction. Some of the first front ribs 73a and some of the second front ribs 73b may be configured such that the spacing therebetween decreases toward the front connection portion 71 and increases toward the front edge portion 72. Other ones of the first front ribs 73a and the second front ribs 73b may be configured such that the spacing therebetween increases toward the front connection portion 71 and decreases toward the front edge portion 72. In addition, one of the second front ribs 73b may be configured such that, relative to a first front rib 73a adjacent on one side in the longitudinal direction of the front support portion 70, the spacing between the second front rib 73b and the first front rib 73a increases toward the front edge portion 72 and decreases toward the front connection portion 71, and, relative to another first front rib 73a adjacent on the opposite side, the spacing between the second front rib 73b and the first front rib 73a decreases toward the front edge portion 72 and increases toward the front connection portion 71. Alternatively, one of the first front ribs 73a may be configured such that, relative to a second front rib 73b adjacent on one side, the spacing between the first front rib 73a and the second front rib 73b decreases toward the front edge portion 72 and increases toward the front connection portion 71, and, relative to another second front rib 73b adjacent on the opposite side, the spacing between the first front rib 73a and the second front rib 73b increases toward the front edge portion 72 and decreases toward the front connection portion 71.

An angle between the front connection portion 71 and the first front rib 73a may be different from an angle between the front connection portion 71 and the second front rib 73b.

Angles between the front connection portion 71 and at least some of the plurality of first front ribs 73a may be different from each other. For example, the plurality of first front ribs 73a may be arranged such that first front ribs 73a located closer to one side in the longitudinal direction (the left side in FIG. 6) have smaller or larger angles with respect to the front connection portion 71.

Angles between the front connection portion 71 and at least some of the plurality of second front ribs 73b may be different from each other. For example, the plurality of second front ribs 73b may be arranged such that second front ribs 73b located closer to one side in the longitudinal direction (the left side in FIG. 6) have larger or smaller angles with respect to the front connection portion 71.

However, according to embodiments, the angle between the front connection portion 71 and the first front rib 73a and the angle between the front connection portion 71 and the second front rib 73b may be the same, the angles between the front connection portion 71 and the plurality of first front ribs 73a may be the same, and the angles between the front connection portion 71 and the plurality of second front ribs 73b may also be the same.

A main component of a force acting on the front lubricating member 40 during shaving is parallel to the shaving direction A. However, in the razor cartridge 1 according to the present embodiment, since the first front ribs 73a and the second front ribs 73b are formed not to be parallel to the shaving direction A, the front lubricating member 40 may be prevented from being separated from the front support portion 70 by the force generated during shaving. Further, since the first front ribs 73a and the second front ribs 73b extend at different angles, and in particular, extend in opposite directions with respect to the shaving direction A, separation of the front lubricating member 40 from the front support portion 70 may be more effectively prevented. In addition, since extension directions of the plurality of first front ribs 73a are different from each other and extension directions of the plurality of second front ribs 73b are different from each other, separation of the front lubricating member 40 from the front support portion 70 may be more effectively prevented.

In order to provide firm support for the front lubricating member 40 and to prevent separation thereof, widths W4 and W5 of the plurality of front ribs 73a, 73b may be formed to be greater than a width W6 of the front edge portion 72, and the front edge portion 72 may be formed to be thicker in the height direction than the plurality of front ribs 73a, 73b, and may be formed to have a step relative to the plurality of front ribs 73a, 73b in an upward direction and/or a downward direction.

Referring to FIG. 6, the front support portion 70 may include a plurality of front through-holes 74.

The front through-holes 74 may be formed to be surrounded by at least three of the front connection portion 71, the front edge portion 72, the first front ribs 73a, and the second front ribs 73b. The front through-holes 74 may be formed in a substantially triangular shape, and may be referred to as triangular through-holes.

Some of the front through-holes 74 may be defined such that the front connection portion 71 forms a first side, the first front rib 73a forms a second side, and the second front rib 73b forms a third side. Some of the front through-holes 74 may be defined such that the front edge portion 72 forms a first side, the first front rib 73a forms a second side, and the second front rib 73b forms a third side. Some of the front through-holes 74 may be defined such that the front connection portion 71 forms a first side, the front edge portion 72 forms a second side, and the first front rib 73a or the second front rib 73b forms a third side.

The plurality of front through-holes 74 may have different shapes and/or sizes, and each of the front through-holes 74 may be asymmetric on both sides with respect to the transverse direction. The plurality of front through-holes 74 may be formed to be asymmetric as a whole with respect to a central axis parallel to the shaving direction A. This may result from, as described above, differences in extension angles between the first front ribs 73a and the second front ribs 73b, differences in extension angles among the plurality of first front ribs 73a, differences in extension angles among the plurality of second front ribs 73b, and/or an arc shape of the front edge portion 72.

The front through-holes 74 define spaces into which the front lubricating member 40 is filled. Accordingly, a shape, size, and an area ratio of the front through-holes 74 with respect to the front support portion are major factors affecting prevention of separation of the front lubricating member 40. The razor cartridge 1 according to the present embodiment includes a plurality of triangular front through-holes 74 having different shapes and/or sizes, thereby sufficiently securing an area of the front through-holes 74 and simultaneously supporting the front lubricating member 40 from various angles, so that separation of the front lubricating member 40 may be more effectively prevented.

By the above-described structure and the like, the front support portion 70 may be formed to be asymmetric with respect to a transverse central axis. Such a configuration more effectively prevents separation of the front lubricating member 40.

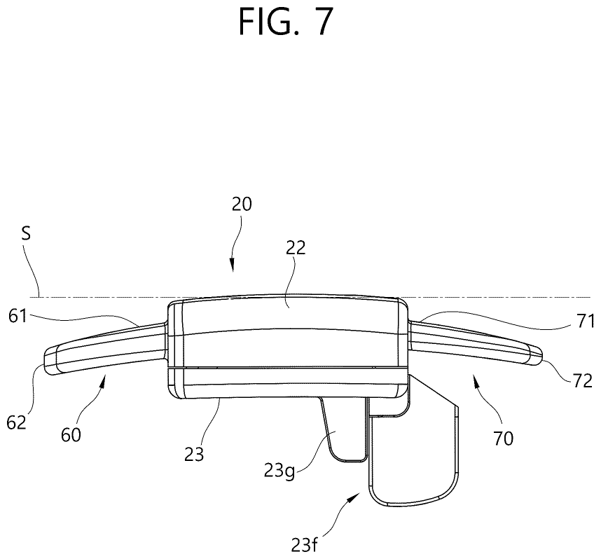

FIG. 7 is a side view of the razor cartridge in which the front lubricating member 40 and the rear lubricating member 30 are removed.

Referring to FIG. 7, the rear support portion 60 and the front support portion 70 may be positioned below the shaving plane S.

However, the front support portion 70 may be positioned lower than the rear support portion 60. Alternatively, a minimum separation distance between the front support portion 70 and the shaving plane S may be greater than a minimum separation distance between the rear support portion 60 and the shaving plane S. Such a configuration allows the front lubricating member 40, which is positioned at a front in the shaving direction A and thus receives relatively greater resistance from the skin, to more smoothly glide over the skin surface. In addition, such a configuration allows a lubricating member having a greater thickness to be formed in an upper region of the front support portion 70 than in an upper region of the rear support portion 60. Accordingly, an initial height of the front lubricating member 40 from the front support portion 70, which is subject to relatively high resistance, may be increased, thereby extending a usable period of the front lubricating member 40. This may alleviate an imbalance in wear rates between the front lubricating member 40 and the rear lubricating member 30, thereby preventing a situation in which the razor cartridge 1 is replaced before the rear lubricating member 30 is sufficiently used.

In addition, the front support portion 70 may be formed to extend forward from the frame 20, and may be formed such that a distance from the shaving plane S increases toward the front. Such a configuration allows a pressing force applied to the skin by the front lubricating member 40 to become stronger toward the rear, thereby allowing the front lubricating member 40 to more smoothly glide over the skin surface. In addition, such a configuration allows the front lubricating member 40 to be formed to be thicker toward the front. Since a front portion of the front lubricating member 40, which has the highest wear rate, may be formed to be relatively thicker, a usage period of the razor cartridge 1 may be extended.

The rear support portion 60 may be formed to extend rearward from the frame 20, and may be formed such that a distance from the shaving plane S increases toward the rear. Such a configuration allows a pressing force applied to the skin by the rear lubricating member 30 to become weaker toward the rear, thereby allowing the rear lubricating member 30 to more smoothly glide over the skin surface. In addition, such a configuration allows the rear lubricating member 30 to be formed to be thicker toward the rear. Since a rear portion of the rear lubricating member 30, which has the highest wear rate, may be formed to be relatively thicker, a usage period of the razor cartridge 1 may be extended.

Those skilled in the art will appreciate that the present disclosure may be implemented in other specific forms without changing the technical spirit or essential features thereof. Therefore, the embodiments described above should be understood as illustrative in all aspects and not limiting. The scope of the present disclosure is defined by the appended claims rather than the foregoing detailed description, and all changes or modifications derived from the meaning and scope of the claims and their equivalents should be construed as being included within the scope of the present disclosure.

What is claimed is:

1. A razor cartridge comprising:
at least one razor blade having a forward-facing cutting edge formed at an end of the razor blade;
a frame configured to longitudinally receive the at least one razor blade such that at least a portion of the cutting edge is exposed upward;
a rear support portion extending rearward from the frame; and
a rear lubricating member supported by the rear support portion,
wherein the rear support portion comprises:
a rear connection portion connected to the frame along a longitudinal direction;
a rear edge portion extending in an arc shape from both sides of the rear connection portion; and
a plurality of rear ribs connecting the rear connection portion and the rear edge portion,
wherein the plurality of rear ribs are formed to extend at angles not parallel to a shaving direction, and
wherein the plurality of rear ribs comprise:
at least one first rear rib extending from the rear connection portion and forming an acute angle on one side with respect to a transverse direction parallel to the shaving direction; and
at least one second rear rib extending from the rear connection portion and forming an acute angle on another side with respect to the transverse direction.

2. The razor cartridge of claim 1, wherein the first rear ribs and the second rear ribs are alternately arranged along the longitudinal direction.

3. The razor cartridge of claim 1, wherein the rear support portion includes a through-hole surrounded by at least three of the rear connection portion, the rear edge portion, the first rear ribs, or the second rear ribs.

4. The razor cartridge of claim 1, wherein an angle between the rear connection portion and the first rear ribs is different from an angle between the rear connection portion and the second rear ribs.

5. The razor cartridge of claim 1, wherein the plurality of rear ribs comprise a plurality of first rear ribs, and
wherein first rear ribs located closer to one side in the longitudinal direction have smaller angles with respect to the rear connection portion.

6. The razor cartridge of claim 1, wherein one of the second rear ribs is formed such that, toward the rear edge portion, the second rear rib becomes closer to an adjacent first rear rib on one side, and becomes farther from an adjacent first rear rib on an opposite side at the rear edge portion.

7. The razor cartridge of claim 1, wherein the plurality of rear ribs comprise a plurality of second rear ribs, and
wherein the plurality of second rear ribs located closer to one side in the longitudinal direction have larger angles with respect to the rear connection portion.

8. The razor cartridge of claim 1, wherein a width of the plurality of rear ribs is greater than a width of the rear edge portion.

9. The razor cartridge of claim 1, wherein the rear support portion is formed to be asymmetric with respect to a transverse central axis.

10. The razor cartridge of claim 1, further comprising:
a front support portion extending forward from the frame; and
a front lubricating member supported by the front support portion,
wherein the front support portion comprises:
a front connection portion connected to the frame along the longitudinal direction;
a front edge portion extending in an arc shape from both sides of the front connection portion; and
a plurality of front ribs connecting the front connection portion and the front edge portion, and
wherein the plurality of front ribs are formed to extend at angles different from the shaving direction.

11. The razor cartridge of claim 10, further comprising:
a front support portion extending forward from the frame and having a plurality of triangular through-holes formed therein; and
a front lubricating member supported by the front support portion.

12. A razor cartridge comprising:
at least one razor blade having a forward-facing cutting edge formed at an end of the razor blade;
a frame configured to longitudinally receive the at least one razor blade such that at least a portion of the cutting edge is exposed upward;
a rear support portion extending rearward from the frame and having a plurality of triangular through-holes; and
a rear lubricating member supported by the rear support portion.

13. The razor cartridge of claim 12, wherein the plurality of triangular through-holes have different shapes.

14. The razor cartridge of claim 12, wherein the rear support portion is formed to be asymmetric with respect to a transverse central axis.

15. The razor cartridge of claim 12, wherein the rear support portion comprises:
a rear connection portion connected to the frame along a longitudinal direction and forming a first side of the triangular through-holes;
a first rear rib extending from the rear connection portion and forming a second side of the triangular through-holes; and
a second rear rib extending from the rear connection portion and forming a third side of the triangular through-holes.

16. The razor cartridge of claim 15, wherein the first rear rib and the second rear rib are formed to extend at angles not parallel to a shaving direction.

17. The razor cartridge of claim 12, wherein the rear support portion comprises:
a rear connection portion connected to the frame along a longitudinal direction;
a rear edge portion extending in an arc shape from both sides of the rear connection portion and forming a first side of the triangular through-holes;
a first rear rib connecting the rear connection portion and the rear edge portion and forming a second side of the triangular through-holes; and
a second rear rib connecting the rear connection portion and the rear edge portion and forming a third side of the triangular through-holes.

18. The razor cartridge of claim 17, wherein the first rear rib and the second rear rib are formed to extend at angles not parallel to a shaving direction.

19. The razor cartridge of claim 17, wherein an angle between the rear connection portion and the first rear rib is different from an angle between the rear connection portion and the second rear rib.

20. The razor cartridge of claim 15, wherein an angle between the rear connection portion and the first rear rib is different from an angle between the rear connection portion and the second rear rib.
